(19) United States
(12) Patent Application Publication
(10) Pub. No.: US 2026/0123566 A1
(43) Pub. Date: May 7, 2026

(54) ROW CLEANER AND ASSEMBLIES WITH TANDEM WALKING MODE FOR ROW PLANTER UNITS

(71) Applicant: Ronald Steve Martin, Elkton, KY (US)

(72) Inventor: Ronald Steve Martin, Elkton, KY (US)

(21) Appl. No.: 19/321,166

(22) Filed: Sep. 5, 2025

Related U.S. Application Data
(60) Provisional application No. 63/691,255, filed on Sep. 5, 2024.

(51) Int. Cl. A01C 5/06

(52) U.S. Cl. CPC A01C 5/064

(57) ABSTRACT

A row cleaner system provides a solution that improves both row cleaning operation in no-till or low-till farming operations to effectively remove debris ahead of the seed planting components and row closing components. The system may include means to selectively configure a row cleaner assembly for one or more of 1) independent row cleaner operation not fixed relative to the depth gauge wheel or basket, 2) selectively engage the row cleaner in a fixed relationship if desirable, and 3) adjustment of the angle of penetration of row closer wheels relative to the depth gauge wheel or basket.

### FIELD OF THE INVENTION

The present disclosure is generally applicable to the field of agricultural equipment, and more particularly for improved row cleaning for use on row planters for farming applications.

### AUTHORIZATION PURSUANT TO 37 C.F.R. § 1.171 (D)(C)

A portion of the disclosure of this patent document contains material which is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND

The background description includes information that may be useful in understanding the present invention. It is not an admission that any of the information provided herein is prior art or relevant to the presently claimed invention, or that any publication specifically or implicitly referenced is prior art.

An example of a prior art rotary row cleaner is described in U.S. Pat. No. 4,785,890 (Martin) entitled GROUND-DRIVEN ROTARY ROW CLEANER, the entirety of which is hereby incorporated herein by reference.

In traditional and longstanding farming methods, tilling or tillage is typically used before planting to prepare a field. Tilling a field has both herbicidal and insecticidal benefits and may serve to break up the earth to enable seedlings to more easily extend root systems. However, there are downsides to tillage that are driving modern farmers towards “low-till” or “no-till” or “strip till” farming systems. In these farming systems, plant matter left over from previous harvests, called residue, is left in the fields between plantings. At the time of planting, a row cleaner system is used at the front or leading portion of a planter row unit to clear only a small portion or “strip” of earth of the residue to enable seeds and fertilizer to be placed in the ground in connection with a coulter or other tillage tool. The row cleaner removes residue and in connection with other planter components, such as coulter, opening or cutting discs and strip till shank, lightly tills the topmost soil or earth to provide for a clear path for seed and fertilizer placement. One key aspect to row cleaner operation is to maintain necessary clearance between the row cleaner and the coulter or other tillage tool for terrain responsive operation. Also, at the trailing end of the planter row unit closing wheels are used to close the seed slot opened during row planting operation.

No-till farming systems provide benefits including increased water retention and absorption, and increased presence of beneficial fungi, bacteria, and fauna (e.g., earthworms). The use of a no-till farming system has the additional benefit of reducing topsoil erosion that may be caused by tilling. In no-till systems it has also been shown that because water retention is greater and soil erosion is reduced, the environmental impact from the runoff of fertilizer, herbicides, and pesticides is also reduced.

The farming system known as strip till farming, is also a conservation method that uses low or minimum tillage. Strip till method provides the soil drying and warming benefits associated with conventional tillage and provides the soil erosion avoidance or protecting advantages of no-till farming. With strip till farming, only the portion of the soil that is to contain the seed row is tilled or disturbed. Strip till method typically requires multiple passes, depending on the strip-till implement used and the field conditions. Typically, rows that have been strip tilled are eight to ten inches wide. In no-till, low till or strip till methods weed suppression may be a problem and so farmers often use cover crops, mulching, laying straw, mowing or herbicides to maintain fields, which leads to extra cost and may lead to more residue during planting.

Planters typically use a cutting disc (or disk) and/or coulter designed to cut through crop residue and break the top crust of the soil. Often row cleaners, such as made by Martin Industries of Elkton, Kentucky, are used to help remove or break up debris ahead of the coulter/cutting disc to allow the coulter or cutting disc to cut into the soil and help an opener make a furrow for more effective and uniform seed planting. After row cleaner, coulter and disk opener prepare the furrow for planting, the seed is dropped into the furrow that has been created (along with fertilizer and other additives as desired) and then a press wheel closes the furrow. Often a closing section is provided to help close the furrow ahead of a second stage press wheel. Row openers clear the path of debris and the coulter or cutting disc breaks the soil crust to facilitate opening and seed depth control for the furrow opener. The row closing section and trailing or second stage press wheel help insure moist soil is in contact with seeds to cover them at proper seed depth as it presses the soil firmly (to varying degrees depending on soil conditions and crop type) around the seeds. The soil is left loose enough to minimize soil crusting to promote healthy and uniform emergence.

The movement towards no-till or low till farming systems has driven the improvement of row cleaner apparatuses for planting systems. Existing row cleaner systems include fixed row cleaners, adjustable row cleaners, and floating row cleaners, which have drawbacks. Fixed row cleaners do not follow or track changes in land elevation as the planter moves over a field. Adjustable and floating row cleaners may not possess the ideal geometry with respect to a planter to provide for optimal row cleaning action by the cleaner wheel assemblies. Additionally, after seeds have been planted the open planted row need to be closed. Existing row closing assemblies comprise drawbacks and limitations. Depending on the camber or toe alignment of closing wheels, the closing action may not be effective and may do harm to germination and emergence of planted seeds. Namely, existing fixed row closing assemblies do not provide an adjustable means to orient the closing wheels to provide desired camber and toe alignment to take into account soil and debris conditions to promote healthy emergence.

The following references, each of which are incorporated by reference herein in their entirety, describe row cleaner designs: U.S. Pat. No. 7,861,660, entitled ADJUSTABLE ROW CLEANER, Martin, issued Jan. 4, 2011; U.S. Pat. No. 8,794,165, entitled ADJUSTABLE ROW CLEANER, Martin, issued Aug. 5, 2014; and in U.S. Pat. No. 9,743,572, entitled ADJUSTABLE ROW CLEANER, Martin, issued Aug. 29, 2017; and such as floating row cleaners provided U.S. Pat. No. 8,631,879B1, entitled COMPACT FLOATING ROW CLEANER, Martin, issued Jan. 21, 2014; and U.S. Pat. No. 9,642,298, entitled COMPACT FLOATING ROW CLEANER, Martin, issued May 9, 2017; and U.S. Prov. Pat. App. No. 62/623,198, entitled COMPACT PARALLEL ARM ROW CLEANER, Martin et al., filed Jan. 28, 2018.

One problem with some row cleaners used with row planters is that they often use a fixed relationship between the down or up pressure exerted on both a depth gauge wheel or basket and the row cleaner frame and wheels used to clear ahead of the planting operation. This results in uneven results when dealing with uneven field ground level conditions. This can cause the row cleaner to aggressively dig into the soil or to ride over the soil and not sufficiently engage in row clearing.

What is needed is an adjustable row cleaning or clearing assembly capable of operating independently or at least in part independently of the depth gauge wheel or basket ahead of seed planting components of row planting units.

What is needed is a row cleaner configuration that is supported by the tool bar and reduces the load on the row planter unit to enhance equipment durability and reduce stress on the machinery.

What is also needed is a single lever user interface to provide for 1) independent row cleaner operation not fixed relative to the depth gauge wheel or basket, 2) selectively engage the row cleaner in a fixed relationship if desirable, and 3) adjustment of the angle of penetration of row closer wheels relative to the depth gauge wheel or basket.

What is also needed is a depth gauge wheel or basket configured to more efficiently break “dirt clods” encountered during seed planting operation in dry soil conditions while also avoiding mud build up in wet soil conditions.

### SUMMARY OF THE INVENTION

The present invention provides a row cleaner system that provides an effective and efficient solution that improves both row cleaning operation in no or low till farming operations to effectively remove debris ahead of the seed planting components and row closing components.

The present invention also provides a means to selectively configure a row cleaner assembly for one or more of 1) independent row cleaner operation not fixed relative to the depth gauge wheel or basket, 2) selectively engage the row cleaner in a fixed relationship if desirable, and 3) adjustment of the angle of penetration of row closer wheels relative to the depth gauge wheel or basket.

Another problem with prior art row cleaner assemblies is the different angle configurations encountered, i.e., the angle of the row cleaner frame determined at the pivot points relative to ground. If the row cleaner frame is generally positioned parallel to ground, i.e., the pivot points generally lie in the same plane with the centers of the row clearing wheels, then unbiased row cleaner wheels are less aggressive, and the weight of the row cleaner and zero-angle position may not adequately perform row clearing operation. In this situation the present invention provides an actuator to bias the row cleaner downward to more aggressively engage the debris layer. On the other hand, if the row cleaner frame is relatively positioned higher up a supporting structure such that the frame forms an angle to ground, i.e., is not parallel to the ground, then the row cleaner may double back on itself and may too aggressively engage the soil and dig a ditch in the area of the furrow. The present invention provides an actuator or airbag or dual air bags to lower or lift the row cleaner to be more or less aggressive and to avoid trenching and avoid insufficient engagement with the debris on top of the soil. The present invention may be used in connection with a control system to provide adjustability within a control range to achieve the desired row cleaning action in light of soil and debris conditions encountered in the field. For example, Martin Industries provides the Smart Clean Bi-Directional Control system. U.S. Pat. Nos. 10,561,054 and 10,918,007 both disclose a smart system to control row cleaner operation and are incorporated in the entirety herein by reference.

The following are some of the key features associated with the improved row cleaner assembly of the present invention. A Walking Tandem Frame-Mounted Design-promotes superior stability and adaptability with the specially designed walking tandem row cleaner frame, adjustment control and complimentary linkage assemblies. This mode is designed to deliver consistent row cleaning performance across diverse terrains. Tandem Operation for Enhanced Depth Control—synchronizes the row cleaner wheels and rear gauge wheel to operate in tandem, preventing the row cleaner from digging in on inclines and being held out of the ground on declines. This feature ensures consistent depth control and precise planting. Dual Air Bags: The Next Generation of Force Adjustment—the improved dual air bag system outlasts traditional cylinders many times over, providing unmatched durability and precision in up and down force adjustments. Experience effortless adaptability to varying soil conditions with a system built for long-term reliability. Effortless Depth Control with Spring-Loaded T Handle—enables user to maintain the perfect planting depth with ease. The spring-loaded T handle provides quick, incremental adjustments for straightforward and efficient depth management.

In addition, the present invention row cleaner configuration is supported by the tool bar and reduces the load on the row planter unit to enhance equipment durability and reduce stress on the machinery.

In connection with one embodiment of the present invention the control system comprises a pneumatic, electrical, hydraulic or electro-mechanical actuator or piston positioned in a desired orientation, relative to a fixed frame. For example, the actuator may be secured at its back end to the frame mounting plate and at the opposite end via an extendable arm to the pivotable row cleaner providing pivoting of the row cleaner relative to the fixed frame in an angular fashion about a row cleaner mounting point or pivot and may include a bushing or bearing. Dual Air Bags are included to provide superior control over up and down force; adapt seamlessly to varying soil conditions and outlast traditional cylinders for increased durability. A Smart Clean Bi-Directional Control System may be used to allow real-time adjustments from the cab, reduce bounce and aid in consistent planting depth, and enhance stability on uneven terrain.

In a first embodiment the present invention provides a row cleaner for attaching to a row planter having a frame mounting plate and or frame securement or connector bars secured to a tool bar or the like to provide a stable mounting for the row cleaner. The row cleaner also provides a depth gauge wheel or basket or “crumbler” configured with cleats or the like to better crumble dirt clods encountered in dry soil conditions and to avoid mud becoming glommed on to the wheel in wet soil conditions, an axle adapted to permit rotation of the depth gauge wheel, and a row cleaner frame assembly comprising a first frame member and a second frame member and having a nose or front or torque brace joining the first and second frame members, the frame members being connected via a pair of struts to upper and lower linkages forming a quad-linkage arrangement, a set of pivot points joining the struts and linkages and a set of bearings or bushings or rollers to enable smooth and effective operation of a biasing member, e.g., an airbag or piston, to provide downforce as needed to properly clear and clean a row in advance of the row planting operation. The present invention also provides an adjustment mechanism configured to engage with the row cleaner frame and struts to selectively operate in either a “walking tandem mode” or in a fixed relative position mode and further adapted to change between a plurality of settings configured to provide relatively more or less aggressiveness of row cleaning operation causing the row cleaner wheels to more or less aggressively engage the soil and debris along the top of the soil.

### BRIEF DESCRIPTION OF THE FIGURES

To facilitate a full understanding of the present invention, reference is now made to the accompanying drawings, in which like elements are referenced with like numerals. These drawings should not be construed as limiting the present invention but are intended to be exemplary and for reference.

In order that the advantages of the cleaning wheel will be readily understood, a more particular description of the assemblies briefly described above will be rendered by reference to specific embodiments illustrated in the appended drawings. Understanding that these drawings depict only typical embodiments of the cleaning wheel and are not therefore to be considered limited of its scope, the assemblies will be described and explained with additional specificity and detail through the use of the accompanying drawings.

FIG. 1 provides a perspective illustration of a first embodiment row cleaner invention and a first embodiment of a depth gauge wheel or basket or “crumbler” for use in connection with a row planter unit or machine.

FIGS. 2-6 provide a perspective illustration featuring row cleaner, crumbler wheel, adjustment selector handle/control, and frame linkage and airbag features of the first embodiment for use with planter components removed for case of illustration.

FIGS. 7-9 provide side, end and perspective illustrations of a first embodiment of a depth gauge wheel or basket or “crumbler” for use in connection with a row cleaner and row planter unit or machine.

FIG. 10 provides an exploded view of the crumbler wheel and axle components.

FIG. 11 provides an exploded view of the T-Handle adjustment/mode selector assembly for use in selecting between a variety of row cleaner modes of operation and settings.

FIG. 12 provides a disconnected view of components of the T-Handle adjustment/mode selector assembly and a row cleaner frame member.

FIGS. 13 and 14 provide perspective views illustrating the T-handle selector mechanism in a “neutral” position for “walking tandem” mode of operation, and in one position associated with an engaged position for fixed relation mode of operation.

FIG. 15 provides a side perspective view with components removed to help illustrate the components used to provide multiple modes of row cleaner operation including the walking tandem mode of operation with partial freedom of movement of the row cleaner frame relative to the strut and quad-linkage components.

FIG. 16 provides a side view featuring the actuator or airbag component and related brackets and plates and bearings and separator block.

FIGS. 17-25 provide a series of side view photographs that illustrate various positioning of row cleaner wheels relative to the depth gauge wheel and quad-linkage components when in actual use to illustrate relative positioning of the components when the T-handle selector mechanism is placed in the neutral position for walking tandem mode of operation.

FIGS. 26-28 provide a series of side view photographs that illustrate various positioning of row cleaner wheels relative to the depth gauge wheel and quad-linkage components when in actual use to illustrate relative positioning of the components when the T-handle selector mechanism is placed in two distinct positions in the engaged position for fixed relation mode of operation.

FIG. 29 is a photo illustrating a side-by-side comparison of the row cleaner in two extreme retracted and extended positions designed to accommodate extreme variations and undulations in field conditions.

PARTS LIST

| | |
|---|---|
| 40 | Tool Bar |
| 50 | Row Planter or Row Planter Unit (e.g., Kinze ® 5000 Series) |
| 52 | Row Planter/Tool Bar Securement or Connector bars |
| 54 | Row Planter frame plate |
| 60 | Row Planter Upper Linkage |
| 62 | Row Planter Lower Linkage |
| 70 | Furrow Opening Section |
| 72 | Cutting or opening disc(s) or coulter |
| 74 | Guage Wheel(s) (L/R) |
| | Row closing section (not shown) |
| 100 | Row Cleaner Lower Subframe |
| 110/111 | Row Clearing Wheel Frames (L/R) |
| 112/113 | Row Clearing Wheel Frame Angled Portion (L/R) |
| 114 | Row Clearing Wheel Frame Nose or Torque Brace |
| 116 | Set or Series of Selectable Row Clearing Wheel Frame |
| | Securement bores or journals or openings (for securing |
| | Rotational Bolt 308) |
| 118/119 | Opening or Journal or Bore for securing (e.g., via bolt with |
| | flange) Row Cleaner Frame 110/111 to Lower Strut 418/419) |
| 120/121 | Opening or Journal or Bore for securing (e.g., via bolt with |
| | flange) Row Cleaner Wheel 202/203 to Row Cleaner Frame 110/ |
| | 111) |
| 122/123 | Opening or Journal or Bore for securing (e.g., via bolt with |
| | flange) Row Cleaner Frame 110/111 to Lower Strut 418/419 via |
| | slotted opening or guide 432/433 |
| 124/125 | Pivot Point Flange Bolt and Nut Fastener for pivoting movement |
| | of the Row Cleaner Frame (110/111) relative to the Lower strut |
| | (418/419) |
| 200 | Clearing Wheel Assembly |
| 202/203 | Cleaner or clearing wheel(s) 202 (LH) and 203 (RH) (e.g., |
| | spike bevel wheel) |
| 204 | Spikes or Teeth |
| 206/207 | Clearing wheel side tread(s) (L/R) |
| 218/219 | Row cleaner wheel hub (LH) and (RH) |
| 220/221 | Clearing Wheel Scraper (L/R) |
| 300 | Depth Gauge Crumbler Wheel or Basket Wheel Section |
| 302 | Depth Gauge Crumbler Wheel or Basket Wheel |
| 303 | Cleat notch or indentation |
| 304 | Depth Gauge Crumbler Wheel Cleats |
| 305 | Bearing Tube Support Opening |
| 306 | Depth Gauge Crumbler Wheel Voids |
| 308 | Rotational Bolt with hex head and threaded end |
| 310 | Bolt Nut with Flange |
| 312 | Spacers (L/R) |
| 314 | Rotational Bearing |
| 316 | DOM Bearing Support Tube |
| 400 | Row Cleaner Biasing Assembly (RCBA) |
| 401 | Row Cleaner Biaser or Actuator or Airbag or Air Spring or |
| | Piston |
| 401a/ | Upper and Lower Biaser or Actuator or Airbag or Piston (e.g., |
| 401b | Firestone ® W023583000 reversible sleeve air spring) |
| 402/403 | Row Cleaner Biasing Assembly Upper Bracket or Linkage Arm |
| | (L/R) |
| 404/405 | Row Cleaner Biasing Assembly Lower Bracket or Linkage Arm |
| | (L/R) |
| 406/407 | Row Cleaner Biasing Assembly Upper (Roller) Bearing (L/R) |
| 408/409 | Row Cleaner Biasing Assembly Lower (Roller) Bearing (L/R) |
| 410/411 | Row Cleaner Biasing Assembly Bearing Separator Block (L/R) |
| 412 | Row Cleaner Biasing Assembly AirBag or Piston Capture Plate |
| 414 | Row Cleaner Biasing Assembly Upper Linkage Fixation Rod |
| 416 | Row Cleaner Biasing Assembly Lower Linkage Fixation Rod |
| 418/419 | Row Cleaner Lower Strut (Slotted) (L/R) |
| 420 | Row Cleaner Biasing Assembly Limiter Block (L/R) |
| 422/423 | Airbag Airstem or air fitting (Airbag control pressure) |
| | (upper/lower) |
| 424/425 | Spacer Block |
| 426 | Upper Airbag Plate with Gussett |
| 427 | Lower Linkage Torque Plate |
| 428 | Airbag Lower Airstem Protector |
| 430 | Airbag Center/Floating Plate |
| 432/433 | Lower Strut 418/419 Slotted Opening or Guide for receiving and |
| | supporting socket head cap screw and bolt/flange to secure Row |
| | Cleaner Frame 110 |
| 434/435 | Opening or Journal or Bore for securing (e.g., via bolt with |
| | flange nut) Lower Strut 418/419 to Upper Linkage 402 |
| 436/437 | Opening or Journal or Bore for securing (e.g., via bolt with |
| | flange nut) Lower Strut 418/419 to Lower Linkage 404 |
| 438/439 | Opening or Journal or Bore for securing (e.g., via bolt with |
| | flange nut) Lower Strut 418/419 to Row Cleaner Frame 110/111 |
| | to Lower Strut 418/419 |
| 440/441 | Movable Fastener or Bearing or Bushing, e.g., socket head cap |
| | screw and bolt/flange, to movably secure Row Cleaner Frame |
| | 110 |
| 442/443 | Pivot Point Flange Bolt and Nut Fastener for pivoting movement |
| | of the Upper Linkage (402/403) relative to the Lower strut |
| | (418/419) |
| 444/445 | Pivot Point Flange Bolt and Nut Fastener for pivoting movement |
| | of the Lower Linkage (404/405) relative to the Lower strut |
| | (418/419) |
| 500 | Row Cleaner/Tool Bar Bracket or Row Planter Mount Assembly |
| | or Section |
| 502/503 | Row Cleaner/Tool Bar Bracket or Row Planter Mount Plate |
| | (L/R) |
| 504 | Row Cleaner or Row Planter Torque Plate |
| 600 | Walking Tandem/Locking Mechanism |
| 601 | Walking Tandem/Locking Mechanism T-Bar or Adjustment |
| | Handle or Control |
| 602 | T-Handle Elongated Member or Rod |
| 603 | T-Handle connector plate engagement members or pins |
| 604 | Walking Tandem/Locking Mechanism Pressure Plate |
| 606 | Walking Tandem/Locking Mechanism Spring or Tensioner |
| 608 | T-Handle Connector Plate |
| 609 | T-Handle Engagement Member Receivers or recesses or slots |
| 610 | T-handle Rod Bushing |
| 611 | T-Handle Connector Plate Opening |
| 612 | Spring Washer |
| 614 | Spring Retaining Ring or Clamp |
| 615 | T-handle Retaining Ring annular recess |
| 616 | Pressure Plate Tab |
| 618 | Pressure Plate Tab |
| 620 | Pressure Tab Receiving Notch (Lower Strut 418) |
| 622 | Pressure Tab Receiving Notch (Lower Strut 418) |
| 623 | Direction/Path of Free Movement in Walking Tandem Mode |
| 624 | T-Handle Connector Plate Row Cleaner Frame Engagement Tab |
| 625 | Row Cleaner Frame Notch or Recess |

### DETAILED DESCRIPTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used herein, “fastener” may mean any suitable fastening means such as a nut and bolt, a rivet, or a pin and cotter pin. Typically, as used herein a fastener refers to a threaded bolt, which may have a hexagonal bolt head, secured by a correspondingly threaded nut having a hexagonal outer surface, wherein one or more washers may be used to permit movement of a fastened object about the bolt. In some embodiments, a locking nut may be used to further secure the nut to the bolt and to prevent the nut from backing off of the threads of the bolt. Where indicated as providing a pivot or pivot point or pivoting, then the fastener may include a bearing or bushing or other well-known mechanism to accomplish a pivot operation. Also, as part of the robustness of the design, oversized pivot bushings engineered for maximum durability are provided to ensure a longer operational life and robust performance while minimizing maintenance needs.

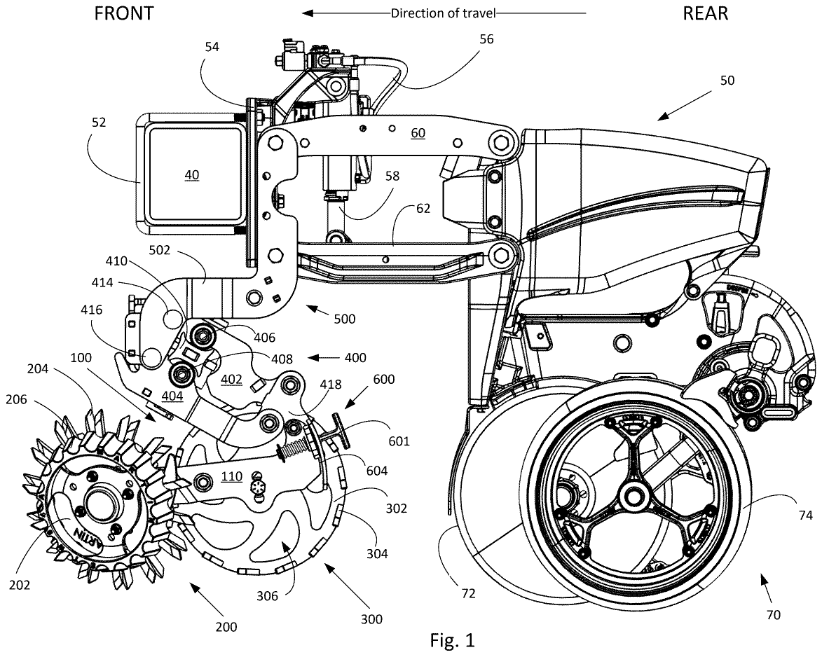

FIG. 1 provides a perspective view illustrating a first embodiment row cleaner invention and a first embodiment of a depth gauge wheel or basket or “crumbler” for use in connection with a row planter unit or machine. The Row Cleaner Assembly 100 is intended for use on the front end of a row planter unit 50 often attached to a Tool Bar 40. For example, Row Planter or Row Planter Unit may be or may be similar to Kinze® 5000 Series row planter units. Row Planter/Tool Bar Securement or Connector bars 52 secure Row Planter frame plate 54 along with Row Planter Upper Linkage 60, Row Planter Lower Linkage 62. The row planter 50 may include Furrow Opening Section 70 having a Cutting or opening disc(s) or coulter 72, Guage Wheel(s) (L/R) 74, and a Row closing section (not shown).

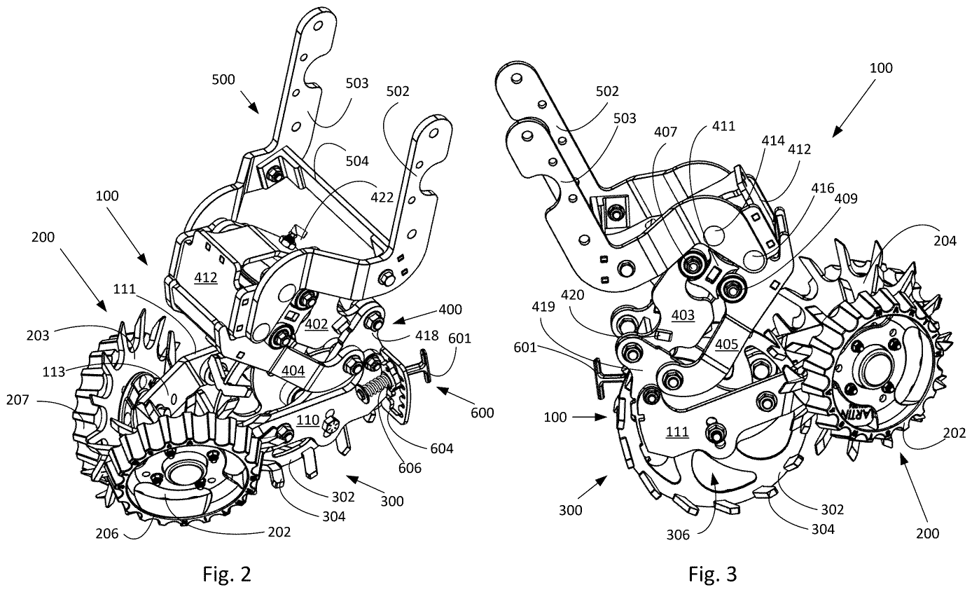

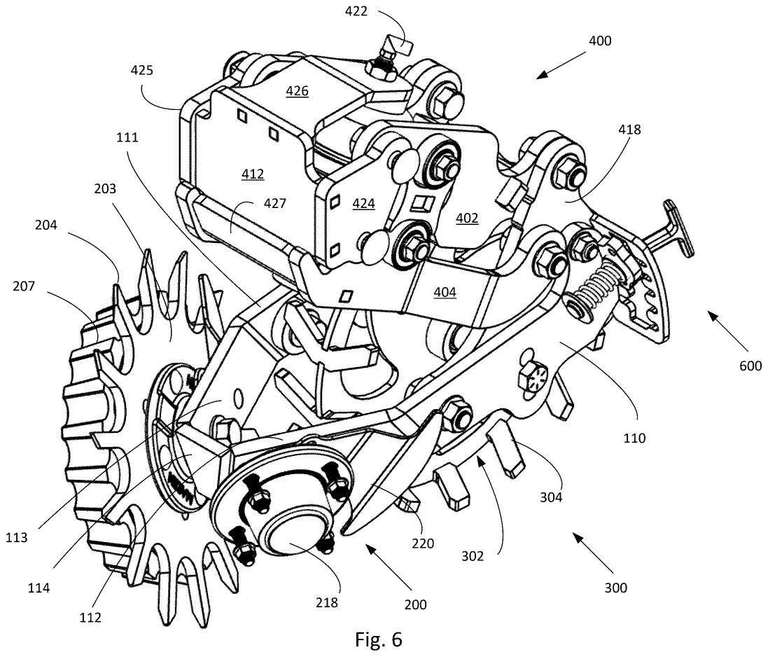

FIGS. 2-6 provide a perspective illustration featuring row cleaner assembly 100, crumbler wheel 300, adjustment selector handle/control 600, and frame linkage and airbag assembly 400 features of the first embodiment for use with planter components removed for ease of illustration. The following description applies to all of the figures included in the specification.

Row Cleaner Assembly and Lower Subframe 100 includes: Row Clearing Wheel Frames (L/R) 110/111; Row Clearing Wheel Frame Angled Portion (L/R) 112/113; Row Clearing Wheel Frame Nose or Torque Brace 114; Set or Series of Selectable Row Clearing Wheel Frame Securement bores or journals or openings (for securing Rotational Bolt 308) 116; Opening or Journal or Bore 118/119 for securing (e.g., via bolt with flange) Row Cleaner Frame 110/111 to Lower Strut 418/419); Opening or Journal or Bore 120/121 for securing (e.g., via bolt with flange) Row Cleaner Wheel 202/203 to Row Cleaner Frame 110/111); Opening or Journal or Bore 122/123 for securing (e.g., via bolt with flange) Row Cleaner Frame 110/111 to Lower Strut 418/419 via slotted opening or guide 432/433; and Pivot Point Flange Bolt and Nut Fastener 124/125 for pivoting movement of the Row Cleaner Frame (110/111) relative to the Lower strut (418/419).

Clearing Wheel Assembly 200 includes: Cleaner or clearing wheel(s) 202 (LH) and 203 (RH) (e.g., spike bevel wheel); Spikes or Teeth 204; Clearing wheel side tread(s) (L/R) 206/207; Row cleaner wheel hub (LH) and (RH) 218/219; and Clearing Wheel Scraper (L/R) 220/221.

Depth Gauge Crumbler Wheel or Basket Wheel Section 300 includes: Depth Gauge Crumbler Wheel or Basket Wheel 302; Cleat notch or indentation 303; Depth Gauge Crumbler Wheel Cleats 304; Bearing Tube Support Opening 305; Depth Gauge Crumbler Wheel Voids 306; Rotational Bolt 308 with hex head and threaded end; Bolt Nut with Flange 310; Spacers (L/R) 312; Rotational Bearing 314; and DOM Bearing Support Tube 316.

Row Cleaner Biasing Assembly (RCBA) 400 Row Cleaner Biaser or Actuator or Airbag or Air Spring or Piston 401 Upper and Lower Biaser or Actuator or Airbag or Piston (e.g., Firestone® WO23583000 reversible sleeve air spring) 401a/401b; Row Cleaner Biasing Assembly Upper Bracket or Linkage Arm (L/R) 402/403; Row Cleaner Biasing Assembly Lower Bracket or Linkage Arm (L/R) 404/405; Row Cleaner Biasing Assembly Upper (Roller) Bearing (L/R) 406/407; Row Cleaner Biasing Assembly Lower (Roller) Bearing (L/R) 408/409; Row Cleaner Biasing Assembly Bearing Separator Block (L/R) 410/411; Row Cleaner Biasing Assembly AirBag or Piston Capture Plate 412; Row Cleaner Biasing Assembly Upper Linkage Fixation Rod 414; Row Cleaner Biasing Assembly Lower Linkage Fixation Rod 416; Row Cleaner Lower Strut (Slotted) (L/R) 418/419; Row Cleaner Biasing Assembly Limiter Block (L/R) 420; Airbag Airstem or air fitting (Airbag control pressure) (upper/lower) 422/423; Spacer Block 424/425; Upper Airbag Plate with Gussett 426; Lower Linkage Torque Plate 427; Airbag Lower Airstem Protector 428; and Airbag Center/Floating Plate 430.

Lower Struts 418/419 includes: Slotted Opening or Guide 432/433 for receiving and supporting socket head cap screw and bolt/flange to secure Row Cleaner Frame 110; Opening or Journal or Bore 432/433 is configured for securing (e.g., via bolt with flange nut) Lower Strut 418/419 to Upper Linkage 402; Opening or Journal or Bore 434/435 for securing (e.g., via bolt with flange nut) Lower Strut 418/419 to Lower Linkage 404; Opening or Journal or Bore 436/437 for securing (e.g., via bolt with flange nut) Lower Strut 418/419 to Row Cleaner Frame 110/111 to Lower Strut 418/419; Movable Fastener or Bearing or Bushing 438/439, e.g., socket head cap screw and bolt/flange, to movably secure Row Cleaner Frame 110; Pivot Point Flange Bolt and Nut Fastener 440/441 for pivoting movement of the Upper Linkage (402/403) relative to the Lower strut (418/419); and Pivot Point Flange Bolt and Nut Fastener 442/443 for pivoting movement of the Lower Linkage (404/405) relative to the Lower strut (418/419).

Row Cleaner/Tool Bar Bracket or Row Planter Mount Assembly or Section 500 includes: Row Cleaner/Tool Bar Bracket or Row Planter Mount Plate (L/R) 502/503; and Row Cleaner or Row Planter Torque Plate 504.

Walking Tandem/Locking Mechanism 600 includes: Walking Tandem/Locking Mechanism T-Bar or Adjustment Handle or Control 601; T-Handle Elongated Member or Rod 602; T-Handle connector plate engagement members or pins 603; Walking Tandem/Locking Mechanism Pressure Plate 604; Walking Tandem/Locking Mechanism Spring or Tensioner 606; T-Handle Connector Plate 608; T-Handle Engagement Member Receivers or recesses or slots 609; T-handle Rod Bushing 610; T-Handle Connector Plate Opening 611; Spring Washer 612; Spring Retaining Ring or Clamp 614; T-handle Retaining Ring annular recess 615; Pressure Plate Tab 616; Pressure Plate Tab 618; Pressure Tab Receiving Notch (Lower Strut 418) 620; Pressure Tab Receiving Notch (Lower Strut 418) 622; Direction/Path of Free Movement in Walking Tandem Mode 623; T-Handle Connector Plate Row Cleaner Frame Engagement Tab 624; and Row Cleaner Frame Notch or Recess 625.

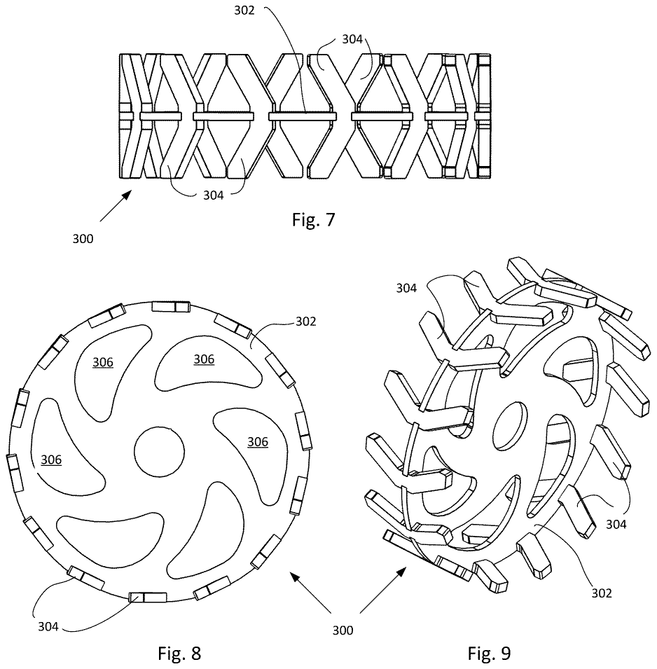

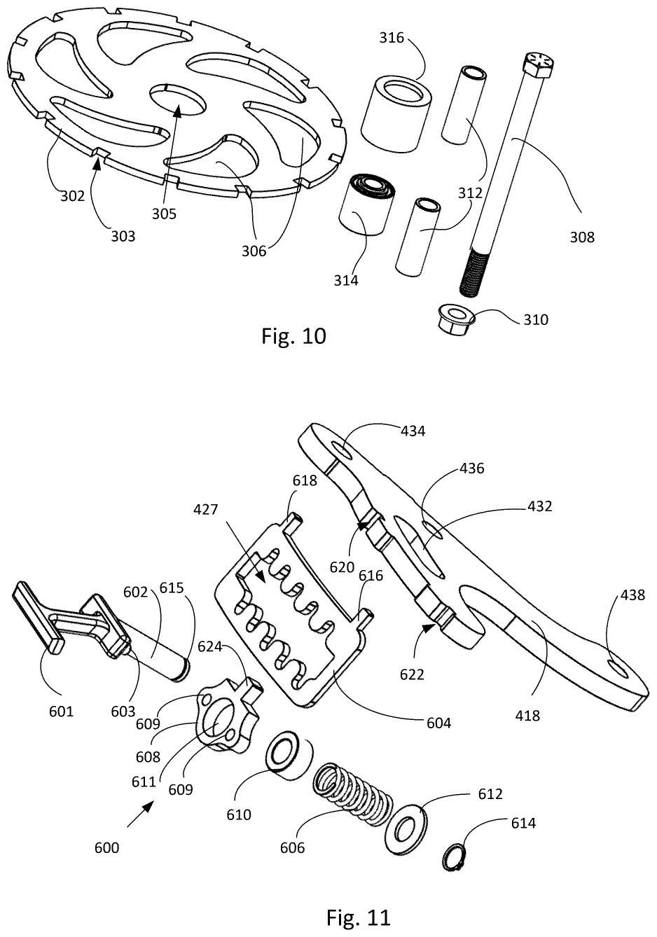

FIGS. 7-9 provide side, end and perspective illustrations of a first embodiment of a depth gauge wheel or basket or “crumbler” for use in connection with a row cleaner and row planter unit or machine. FIG. 10 provides an exploded view of the crumbler wheel and axle components. As shown Depth Gauge Crumbler Wheel or Basket Wheel Section 300 includes: Depth Gauge Crumbler Wheel or Basket Wheel 302; Cleat notch or indentation 303; Depth Gauge Crumbler Wheel Cleats 304; Bearing Tube Support Opening 305; Depth Gauge Crumbler Wheel Voids 306; Rotational Bolt 308 with hex head and threaded end; Bolt Nut with Flange 310; Spacers (L/R) 312; Rotational Bearing 314; and DOM (Drawn Over Mandrel) Bearing Support Tube 316. The Crumbler with the thin wheel profile and the laterally extending cleats in a reverse, swoop forward chevron or v-shaped configuration with the point of the “v” rotating downwardly onto the soil surface with the ends of the “v” exiting as the wheel 302 rotates around to clear the surface. The cleats have 90-degree edges and the thin wheel profile also has a sharp 90-degree edge as it drives through the soil surface. In this manner the “v” cleats and thin line wheel edge effectively break apart dirt clods in dry conditions and promote dislodgement of mud in wet conditions. The crumbler wheel working in combination with the row clearing wheels 202/203 provide and improved mechanism for clearing a row for planting of debris and break up soil for planting operation of the row planter 50. The crumbler basket/wheel invention creates a clean seedbed that enhances soil consistency and improves seed-to-soil contact.

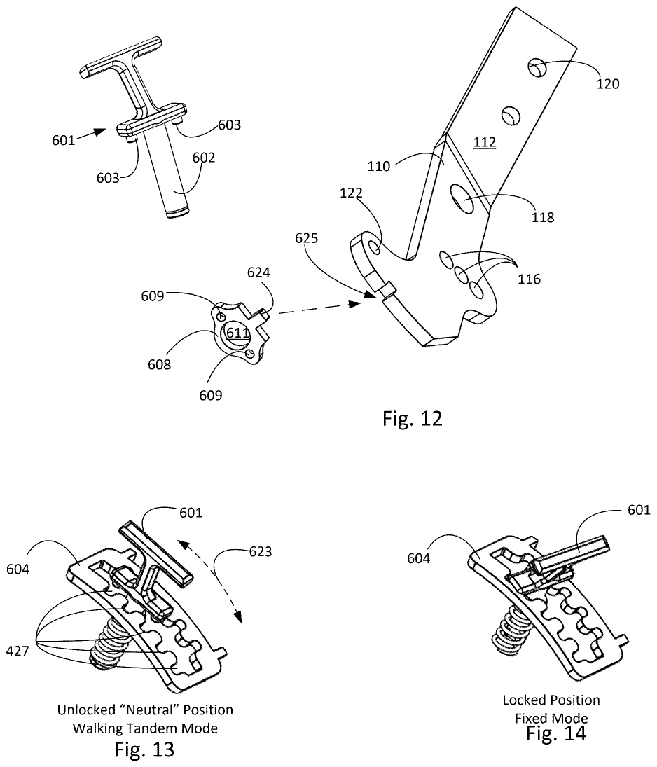

FIG. 11 provides an exploded view of the T-Handle adjustment/mode selector assembly for use in selecting between a variety of row cleaner modes of operation and settings. In particular, the T-handle adjustment assembly 600 is configured to allow a user to selectively choose between a “neutral” position for walking tandem mode of operation and an “engaged” position at one of a plurality of selectable engagement positions based on the desired level of soi engagement aggressiveness. FIG. 12 provides a disconnected view of components of the T-Handle adjustment/mode selector assembly and a row cleaner frame member. FIGS. 13 and 14 provide perspective views illustrating the T-handle selector mechanism in a “neutral” position for “walking tandem” mode of operation, and in one position associated with an engaged position for fixed relation mode of operation.

As shown, Walking Tandem/Locking Mechanism 600 includes Walking Tandem/Locking Mechanism T-Bar or Adjustment Handle or Control 601 having a “T”-shaped top or handle portion and an Elongated Member or Rod portion 602, and having T-Handle connector plate engagement members or pins 603. The adjustment assembly 600 includes a Walking Tandem/Locking Mechanism Pressure Plate 604 having a series of notches configured to present a plurality of positions 427 for a user to select from in connection with fixed relative positioning engagement mode of operation when the handle is pulled against the bias pressure of the spring 606 and rotated 90-degrees from a neutral position. The user places the handle 601 in a desired position of the set of positions 427 by positioning the pins or engagement members 603 into the desired slot or position 427. Walking Tandem/Locking Mechanism Spring or Tensioner 606 biases the handled against pressure plate 604 to hold the handle in the deployed position during use. T-Handle Connector Plate 608 includes T-Handle Engagement Member Receivers or recesses or slots 609 configured to matingly receive T-Handle connector plate engagement members or pins 603 and has an opening 611 configured to receive T-handle Rod Bushing 610 into T-Handle Connector Plate Opening 611 through which is received Elongated Member or Rod portion 602, which is also disposed into and within spring 606. Spring Retaining Ring or Clamp 614, which is configured to be received into T-handle Retaining Ring annular recess 615 and in connection with Spring Washer 612 holds T-handle in place under a biasing pressure against connector plate 608. Pressure Plate 604 includes a pair of Tabs 616 and 618. Pressure Plate Tabs 616/618 are configured to be disposed within Pressure Tab Receiving Notch (Lower Strut 418) 620 and Pressure Tab Receiving Notch (Lower Strut 418) 622.

As shown in FIG. 12, Tab 624 of connector plate 608 is configured to be received into Row Cleaner Frame Notch or Recess 625. As shown in FIG. 13, with T-handle placed in the neutral position, the handle and Row Cleaner Frame 110/111 are able to move along the Direction/Path of Free Movement in Walking Tandem Mode 623. As shown in FIG. 14, with the T-Handle 601 rotated 90-degrees and with pins 603 disposed within a pair of positioning notches 427, the row cleaner frame 110/111 is locked and fixed in position to travel in fixed relation with lower strut 418/419. Connector Plate Row Cleaner Frame Engagement Tab 624 remains in position in row cleaner frame notch 625.

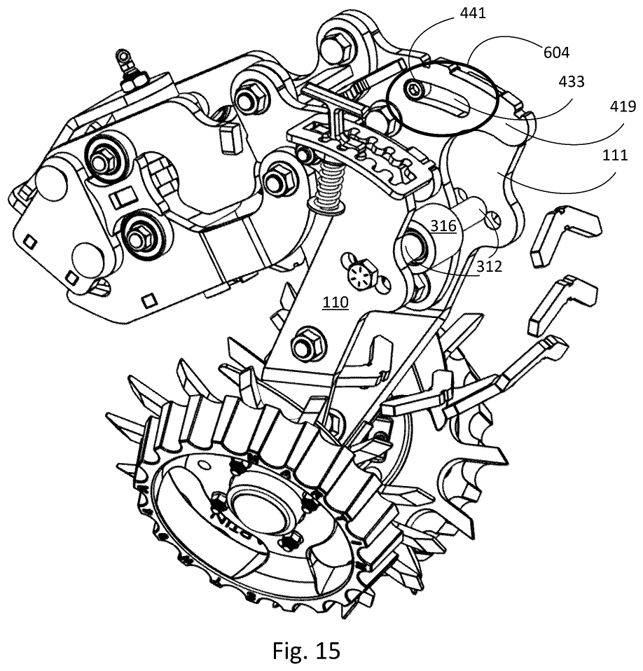

FIG. 15 provides a side perspective view with components removed to help illustrate the components used to provide multiple modes of row cleaner operation including the walking tandem mode of operation with partial freedom of movement of the row cleaner frame relative to the strut and quad-linkage components. As shown, Lower Struts 418/419 include Slotted Openings or Guides 432/433 adapted to receive and support socket head cap screw and bolt/flange to secure Row Cleaner Frame 110/111. Opening or Journal or Bore 432/433 are configured to secure (e.g., via bolt with flange nut) Lower Strut 418/419 to Upper Linkage 402. Opening or Journal or Bore 434/435 are adapted to secure (e.g., via bolt with flange nut) Lower Strut 418/419 to Lower Linkage 404. Opening or Journal or Bore 436/437 are adapted to secure (e.g., via bolt with flange nut) Lower Strut 418/419 to Row Cleaner Frame 110/111 to Lower Strut 418/419. Movable Fastener or Bearing or Bushing 438/439, e.g., socket head cap screw and bolt/flange, movably secure Row Cleaner Frame 110. Pivot Point Flange Bolt and Nut Fastener 440/441 is configured for pivoting movement of the Upper Linkage (402/403) relative to the Lower strut (418/419). Pivot Point Flange Bolt and Nut Fastener 442/443 is configured for pivoting movement of the Lower Linkage (404/405) relative to the Lower strut (418/419).

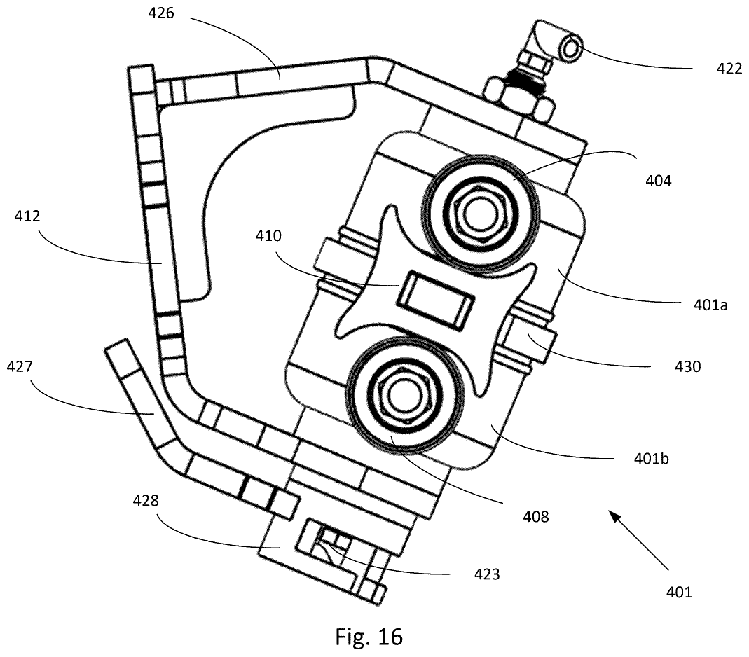

FIG. 16 provides a side view featuring the actuator or airbag component and related brackets and plates and bearings and separator block. Row Cleaner Biasing Assembly (RCBA) 400 includes one or more Row Cleaner Biaser 401, which may be one or more Actuator or Airbag or Air Spring or Piston. Here a dual airbag arrangement is provided with Upper and Lower Biaser or Actuator or Airbag or Piston (e.g., Firestone® WO23583000 reversible sleeve air spring) 401a/401b. Row Cleaner Biasing Assembly Upper Bracket or Linkage Arm (L/R) 402/403, Row Cleaner Biasing Assembly Lower Bracket or Linkage Arm (L/R) 404/405, and Row Cleaner Biasing Assembly AirBag or Piston Capture Plate 412 serve to help retain the Biaser 401 in place. On either side of the Biaser 401 are Row Cleaner Biasing Assembly Upper (Roller) Bearing (L/R) 406/407 and Row Cleaner Biasing Assembly Lower (Roller) Bearing (L/R) 408/409, which respectively act upon Row Cleaner Biasing Assembly Bearing Separator Blocks (L/R) 410/411 and upper and lower linkages.

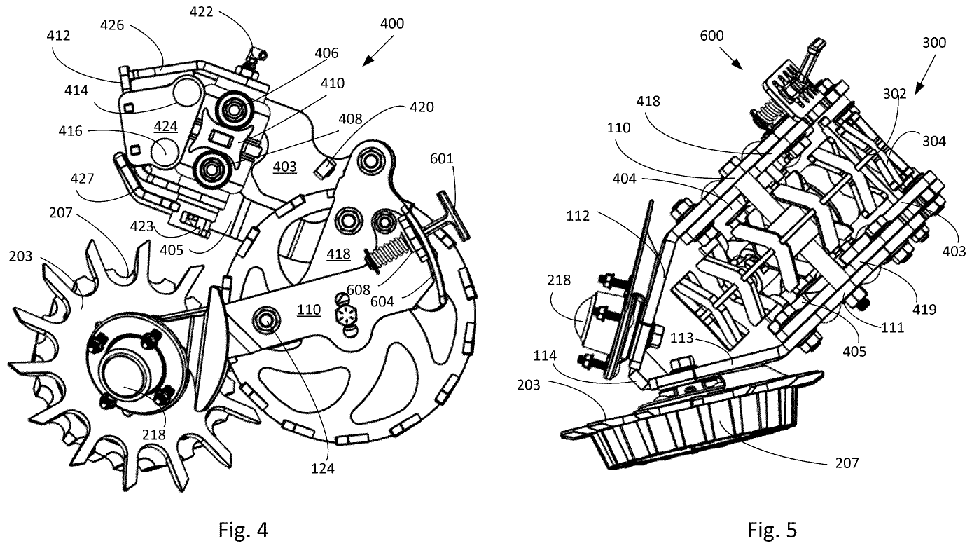

Referring back to FIGS. 4 and 5, Row Cleaner Biasing Assembly Upper Linkage Fixation Rod 414 and Row Cleaner Biasing Assembly Lower Linkage Fixation Rod 416 supported by Spacer Blocks 424/425 serve to secure Row Cleaner Biasing Assembly Upper Bracket or Linkage Arm (L/R) 402/403 and Row Cleaner Biasing Assembly Lower Bracket or Linkage Arm (L/R) 404/405 to Row Cleaner/Tool Bar Bracket or Members 502/503 to provide a stable platform relative to the Tool Bar 40. Row Cleaner Biasing Assembly Limiter Block (L/R) 420 is shown disposed on Upper Bracket or Linkage Arm 403. Row Cleaner Lower Strut (Slotted) (L/R) 418/419 is sandwiched or placed intermediate, respectively, upper and lower linkages 402/403 and 404/405 and Row Cleaner Frames 110/111. Airbag Airstem or air fitting (Airbag control pressure) (upper/lower) 422/423 are connected to the top and bottom ports of Airbag 401. The Biasing Assembly 400 also includes Upper Airbag Plate with Gussett 426, Lower Linkage Torque Plate 427, Airbag Lower Airstem Protector 428, and Airbag Center/Floating Plate 430.

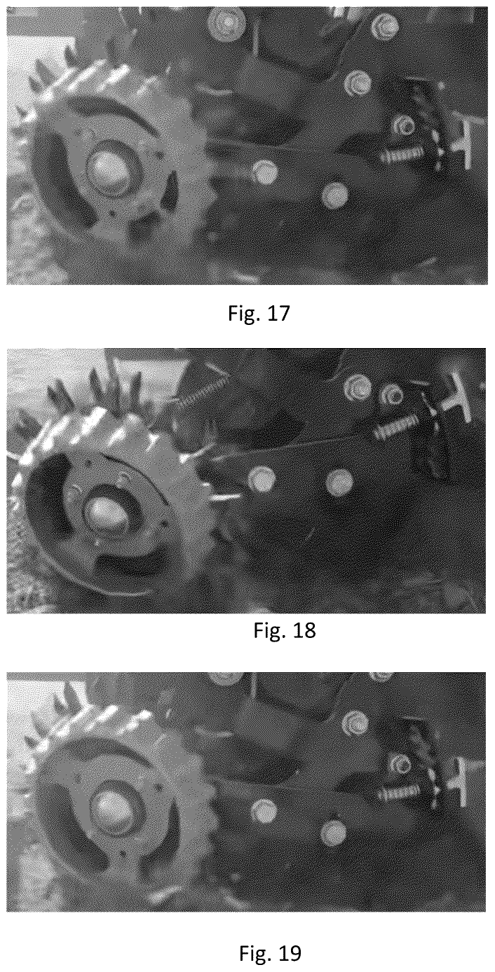

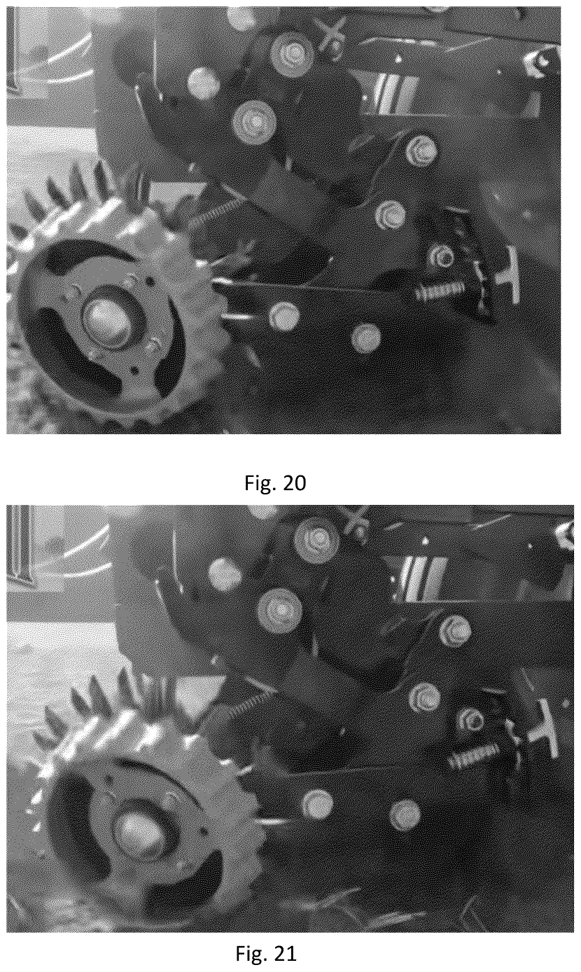

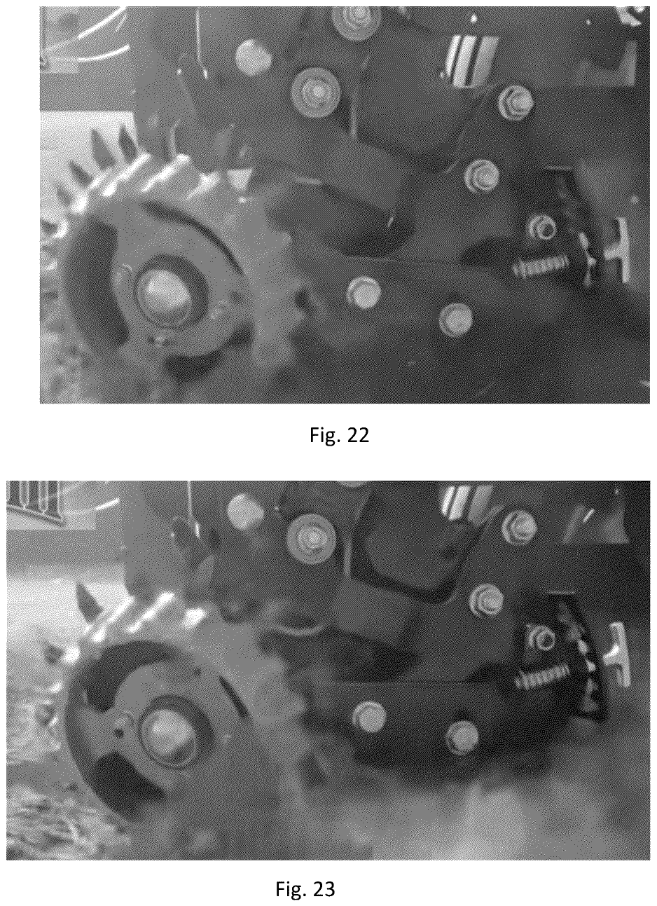

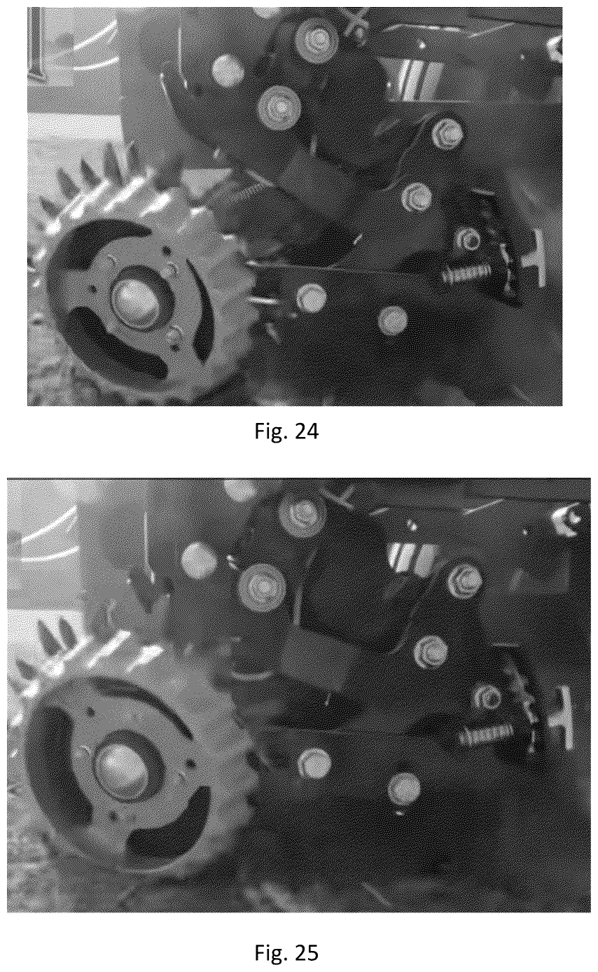

FIGS. 17-25 provide a series of side view photographs that illustrate various positioning of row cleaner wheels relative to the depth gauge wheel and quad-linkage components when in actual use to illustrate relative positioning of the components when the T-handle selector mechanism is placed in the neutral position for walking tandem mode of operation.

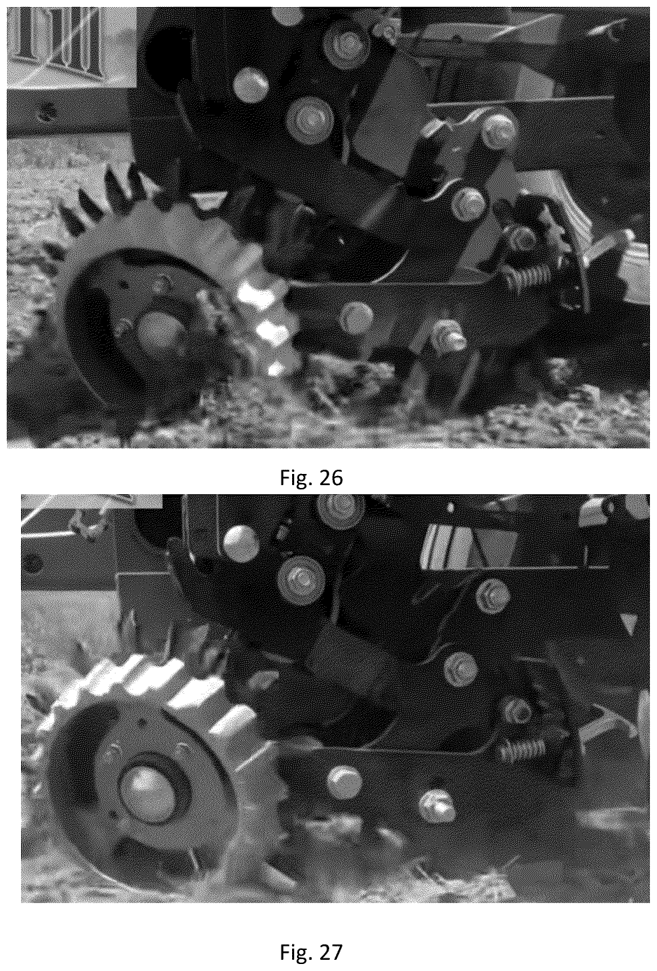

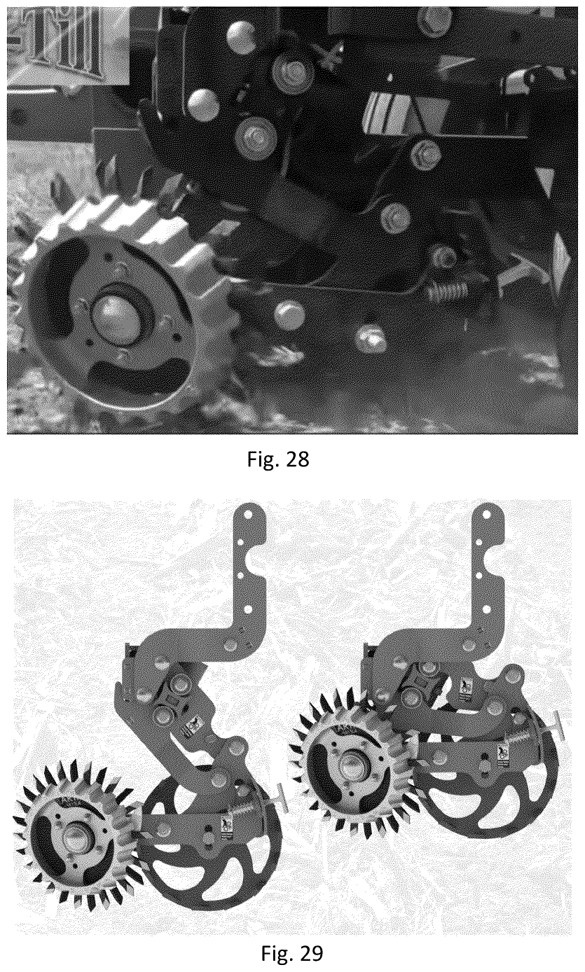

FIGS. 26-28 provide a series of side view photographs that illustrate various positioning of row cleaner wheels relative to the depth gauge wheel and quad-linkage components when in actual use to illustrate relative positioning of the components when the T-handle selector mechanism is placed in two distinct positions in the engaged position for fixed relation mode of operation. As shown, in a first position the row cleaner is angled downward and more aggressively engages with the soil. In the second position the row cleaner is more elevated relative to the ground and does not engage the soil as aggressively.

Depending on the field and soil conditions, a user may select the walking tandem mode of operation or choose one of the fixed position to achieve desired results.

FIG. 29 is a photo illustrating a side-by-side comparison of the row cleaner in two extreme retracted (right) and extended (left) positions designed to accommodate extreme variations and undulations in field conditions.

While the invention has been described by reference to certain preferred embodiments, it should be understood that numerous changes could be made within the spirit and scope of the inventive concept described. In implementation, the inventive concepts may be automatically or semi-automatically, i.e., with some degree of human intervention, performed. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

It should be noted that the present systems and/or methods are not limited to the specific embodiments described herein, but is intended to apply to all similar systems and/or methods for removing debris and/or providing a certain amount of tilling. Modifications and alterations from the described embodiments will occur to those skilled in the art without departure from the spirit and scope of the present systems and/or methods. It should be noted that the present invention is not limited to the specific embodiments pictured and described herein but is intended to apply to all similar methods for ground surface penetration during operation of strip till machinery. Accordingly, modifications and alterations from the described embodiments will occur to those skilled in the art without departure from the spirit and scope of the present invention, the scope of which is only limited by the appended claims that follow.

What is claimed is:

1. A row cleaner for attaching to a row planter having a frame mounting plate and or frame securement or connector bars secured to a tool bar or the like to provide a stable mounting for the row cleaner, the row cleaner comprising:
a depth gauge wheel or basket or “crumbler” configured with cleats or the like to better crumble dirt clods encountered in dry soil conditions and to avoid mud becoming glommed on to the wheel in wet soil conditions;
an axle adapted to permit rotation of the depth gauge wheel;
a row cleaner frame assembly comprising a first frame member and a second frame member and having a nose or front or torque brace joining the first and second frame members, wherein the frame members are connected via a pair of struts to upper and lower linkages forming a quad-linkage arrangement;
a set of pivot points joining the struts and linkages; and
a set of bearings or bushings or rollers to enable smooth and effective operation of a biasing member to provide downforce as needed to properly clear and clean a row in advance of the row planting operation.

2. The row cleaner of claim 1, wherein the biasing member is an airbag or piston.

3. The row cleaner of claim 1 further comprising an adjustment mechanism configured to engage with the row cleaner frame and struts to selectively operate in either a “walking tandem mode” or in a fixed relative position mode and further adapted to change between a plurality of settings configured to provide relatively more or less aggressiveness of row cleaning operation causing the row cleaner wheels to more or less aggressively engage the soil and debris along the top of the soil.
